(19) United States
(12) Patent Application Publication
(10) Pub. No.: US 2026/0200017 A1
(43) Pub. Date: Jul. 16, 2026

(54) NANO-SILVER BONDING PASTE AND LOW-TEMPERATURE SINTERING PROCESS USING THE SAME

(71) Applicant: KOSEMI Materials Limited, Hong Kong (HK)

(72) Inventors: Ka I LEE, Hong Kong (HK); Yuechen WANG, Hong Kong (HK); Xueling ZHANG, Shenzhen (CN); Rong LI, Shenzhen (CN); Chi Ho KWOK, Hong Kong (HK); Li FU, Hong Kong (HK)

(21) Appl. No.: 19/021,034

(22) Filed: Jan. 14, 2025

(51) Int. Cl. B23K 35/02; B23K 35/34

(52) U.S. Cl. CPC B23K 35/025; B23K 35/34

(57) ABSTRACT

A silver paste for low-temperature sintering process includes a liquid silver adduct component, silver particles, and at least one solvent. The liquid silver adduct component is with a weight percentage ranging from 10% to 20%, in which the liquid silver adduct component is a metal-organic complex comprising a silver salt, an organic acid, and primary amines coordinated to a silver metal center, serving as a silver precursor with a decomposition temperature below 250° C. The silver particles are with a weight percentage ranging from 50 to 80% and have an average particle size ranging from 3 μm to 15 μm; and. The solvent is with a weight percentage ranging from 5% to 15%.

### TECHNICAL FIELD

The present invention relates to metal paste technologies, particularly to high-performance nano-Ag bonding materials for low-temperature and fast sintering processes.

### BACKGROUND

In recent years, technologies using metal paste to form metal conductors through sintering by heating have emerged. For example, metal paste is applied to a substrate, another electronic device is placed on the substrate, and these two are connected through the metal paste. Subsequently, the metal particles in the metal paste are sintered by heating, forming a conductor with good electrical conductivity. Due to considerations of energy saving and material costs, the sintering temperature has been gradually reduced, making low-temperature sintering techniques a focus of research.

For instance, as mounting substrates for electronic devices, traditionally, flexible substrates capable of withstanding several hundred degrees Celsius have been used. These substrates, while possessing excellent heat resistance, are expensive to manufacture. Therefore, researchers have started exploring the use of substrates with lower heat resistance but lower costs to reduce overall manufacturing costs. However, the lower heat resistance of these substrates limits the maximum temperature during processing, making the development of low-temperature sintering technology particularly important.

According those requirements, silver paste has gained widespread attention as a material that can effectively sinter into a silver conductor in low-temperature environments. This material not only completes sintering at relatively lower temperatures but also maintains good electrical conductivity. Therefore, the application of silver paste in low-temperature sintering technology provides an economical and efficient solution for the bonding process of electronic devices, especially suitable for cases using substrates with lower heat resistance. Such technological advancements not only meet the current market demand for low-cost, high-performance electronic products but also drive further developments in electronic manufacturing processes.

### SUMMARY OF INVENTION

In accordance with a first aspect of the present invention, a method for low-temperature sintering process using a silver paste is provided. The method includes steps as follows: forming a silver paste by at least mixing a liquid silver adduct component with a weight percentage ranging from 10% to 20%, silver particles with a weight percentage ranging from 50 to 80%, and at least one solvent with a weight percentage ranging from 5% to 15%, wherein the liquid silver adduct component is a metal-organic complex comprising an organic acid and primary amines coordinated to a silver metal center, serving as a silver precursor with a decomposition temperature below 250° C., and wherein the silver particles have an average particle size ranging from 3 μm to 15 μm; performing a pre-cure process for the silver paste, comprising heating the silver paste in a heating chamber at a pre-cure temperature ranging from 100° C. to 150° C., such that the silver adduct component in the silver paste decomposes to form silver nanoparticles for adhesion onto surfaces of the silver particles; and performing a sintering process, comprising heating the pre-cured silver paste under a sintering temperature higher than the pre-cure temperature under pressure of 5-30 MPa to facilitate connection of the silver particles via the silver nanoparticles.

In accordance with a second aspect of the present invention, a method for low-temperature sintering process using a silver paste is provided. The method includes steps as follows: forming a silver paste by at least mixing a liquid silver adduct component with a weight percentage ranging from 10% to 20%, silver particles with a weight percentage ranging from 50 to 80%, and at least one solvent with a weight percentage ranging from 5% to 15%, wherein the liquid silver adduct component is a metal-organic complex comprising a silver salt, an organic acid, and primary amines coordinated to a silver metal center, serving as a silver precursor with a decomposition temperature below 250° C., and wherein the silver particles have an average particle size ranging from 3 μm to 15 μm; applying the silver paste to a top surface of a substrate; heating the substrate with the silver paste in a heating chamber at a pre-cure temperature ranging from 100° C. to 150° C., such that the silver adduct component in the silver paste decomposes to form silver nanoparticles for adhesion onto surfaces of the silver particles; and placing a die onto the silver paste for bonding the die to the substrate, wherein the bonding is performed at a bonding temperature; performing a sintering process, comprising heating the pre-cured silver paste under a sintering temperature higher than the pre-cure temperature under pressure of 5-30 MPa to facilitate connection of the silver particles via the silver nanoparticles.

In accordance with a third aspect of the present invention, a silver paste for low-temperature sintering process is provided. The silver paste includes a liquid silver adduct component, silver particles, and at least one solvent. The liquid silver adduct component is with a weight percentage ranging from 10% to 20%, in which the liquid silver adduct component is a metal-organic complex comprising a silver salt, an organic acid, and primary amines coordinated to a silver metal center, serving as a silver precursor with a decomposition temperature below 250° C. The silver particles are with a weight percentage ranging from 50 to 80% and have an average particle size ranging from 3 μm to 15 μm; and. The solvent is with a weight percentage ranging from 5% to 15%.

By the above configuration, the inventive solution can achieve metal surface sintering in which nanoparticles and microparticles are interconnected at low temperatures with low air porosity and high shear strength. This involves in situ generation of silver nanoparticles acting as a die-attach material for semiconductor devices.

### BRIEF DESCRIPTION OF DRAWINGS

Embodiments of the invention are described in more details hereinafter with reference to the drawings, in which:

FIG. 1 depicts the chemical formula of the silver precursor according to one embodiment of the present invention, consisting of a silver metal center, conjugated with an organic acid and primary amines.

FIG. 2 depicts a flowchart of a sintering process according to one embodiment of the present invention;

FIGS. 3A, 3B, and 3C depict schematic drawings of a flowchart for the sintering process according to one embodiment of the present invention; and

FIGS. 4A, 4B, and 4C are schematic diagrams illustrating the transformation process of the silver paste from a microscopic perspective according to one embodiment of the present invention.

### DETAILED DESCRIPTION OF THE INVENTION

In the following description, nano-Ag bonding materials and low-temperature and fast sintering processes using the same and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present disclosure, metallo-organic complexes can be thermally decomposed to form nanoparticles and interconnecting the two metal surfaces (e.g., sintered bodies) under pressurized condition are provided.

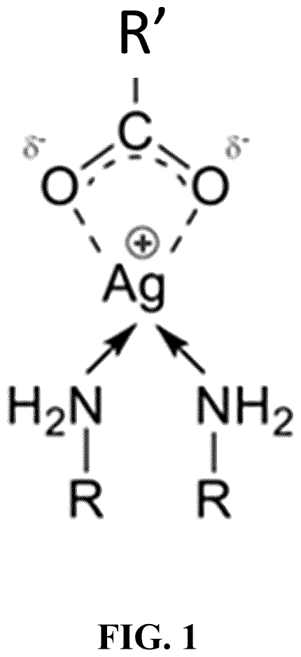

Specifically, FIG. 1 shows the chemical formula of the silver precursor according to one embodiment of the present invention, consisting of a silver metal center, conjugated with an organic acid and primary amines, which the conjugates would decompose and detach from the silver metal center upon heating under a pre-sintering temperature, freeing the silver metal center in the form of silver nanoparticle. In some embodiments, the organic acid may be hexanoic acid, octanoic acid, oleic acid, palmitic acid, caprylic acid, arachidic acid, lauric acid, caproic acid, carboxylic acid, myristic acid, stearic acid or combinations thereof. The chemical structure shown in FIG. 1 is merely an example; in practice, using different organic acids may result in the formation of products with different chemical structures.

Referring to the chemical formula of the silver precursor, R and R′ are individually selected from any alkyl substituents; and the two amines conjugated to the silver metal center must be primary amines. The chemical structure of the silver precursor is designed as above to be able to maintain chemical stability as a separated liquid component under room temperature and atmospheric pressure, while having a low decomposition temperature such that the silver metal centers are freed as free-standing silver nanoparticles for further sintering processes without the need of high-temperature pre-sintering processing.

Accordingly, in the present invention, a novel nanoparticle-generating precursor is proposed, which is a metal-organic complex composed of a silver salt, an organic acid, and primary amines coordinating to the silver metal center.

In one embodiment, a metal-organic complex and silver salt coordinating with primary amine ligands are applied to form a liquid precursor that can be isolated and remains stable at room temperature. Consequently, in practical applications, metal flakes and particles can be formulated into a metal sintering slurry using the nanoparticle-generating precursor as afore-mentioned.

Specifically, in the present disclosure, the use of the metal sintering slurry enables a uniform and low-temperature sintering process in situ, facilitating the generation of nanoparticles for metal surface connection.

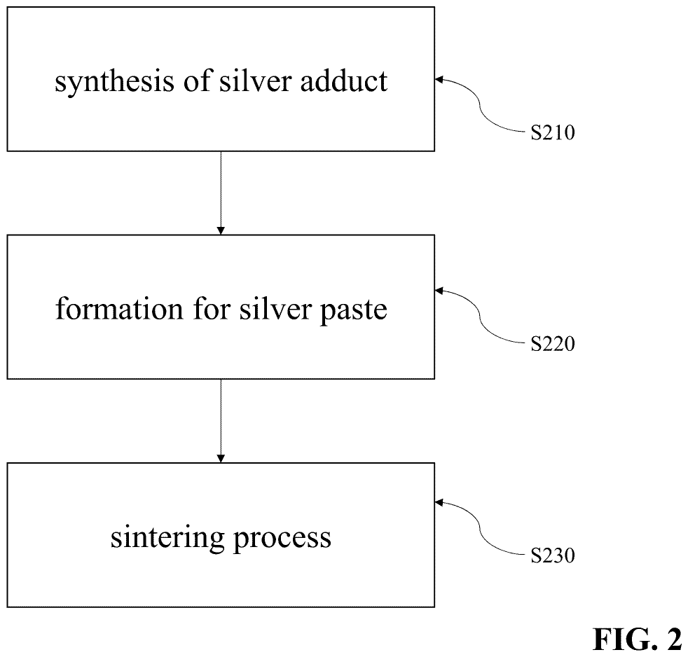

FIG. 2 depicts a flowchart of a sintering process according to one embodiment of the present invention. The sintering process includes steps S210, S220, and S230. Briefly, the method involves synthesizing a silver adduct, which is then mixed with silver particles to act as a binder that facilitates the sintering process.

The step S210 is synthesis of silver adduct. In various embodiment, synthesis of silver adduct is applied using different receipts according to the desired requirements.

In one embodiment, the synthesis of the silver adduct is performed as follows: sodium hydroxide and an organic acid in a mole ratio of A:B are dissolved in an aqueous medium to form a mixed solution. In some embodiments, a ratio of A to B ranges from 0.2 to 5; For example, the ratio is 0.5, 1, or 2. Silver nitrate, in the same mole ratio as the organic acid (i.e., A:B), is also dissolved in the aqueous medium to obtain a silver nitrate solution. The silver nitrate solution is then added dropwise into the mixed solution to obtain a silver salt. The silver salt is filtered and dried in a vacuum oven. A mole ratio of silver salt to primary amine in C:D is then used to obtain a liquid silver adduct component. In some embodiments, a ratio of C to D ranges from 0.1 to 2; For example, the ratio is 0.3, 0.5, or 0.7.

In one embodiment, the synthesis of the silver adduct is performed as follows: silver nitrate and the organic acid in a mole ratio of E:F are dissolved in an aqueous medium to form a silver salt. In some embodiments, a ratio of E to F ranges from 0.2 to 5; For example, the ratio is 0.5, 1, or 2. The silver salt is then filtered and dried in a vacuum oven. A mole ratio of silver salt to primary amine in G:H is then used to obtain a liquid silver adduct component. In some embodiments, a ratio of G to H ranges from 0.1 to 2; For example, the ratio is 0.3, 0.5, or 0.7.

In this regard, the liquid silver adduct component is composed of a silver salt with primary amine ligands coordinated to the metal center, obtaining a precursor that can be stabilized at room temperature. The silver salt includes saturated fatty acids (e.g., hexanoic acid, octanoic acid, oleic acid, palmitic acid, caprylic acid, arachidic acid, lauric acid, caproic acid, carboxylic acid, myristic acid, stearic acid or combinations thereof.) and the primary amine ligands are composed of straight-chain primary amines (e.g., heptylamine, tetradecylamine, hexadecylamine, hexylamine, dodecylamine, decylamine, octadecylamine, octylamine, oleylamine and combinations thereof).

After obtaining the liquid silver adduct component, step S220 is performed for silver paste formation. In various embodiments, silver paste formation is carried out using different recipes for the silver paste formulation, which may involve variations in solvents and additives.

In one embodiment, the silver paste formulation is as follows: the liquid silver adduct component with a weight percentage ranging from 10% to 20% or from 10% to 15%, silver particles with a weight percentage ranging from 50 to 75% or from 70% to 80%, and at least one solvent with a weight percentage ranging from 5% to 15% are mixed to form a silver paste.

In one embodiment, the silver paste formulation is as follows: the liquid silver adduct component with a weight percentage ranging from 10% to 20% or from 10% to 15%, silver particles with a weight percentage ranging from 50 to 75% or from 70% to 80%, at least one solvent with a weight percentage ranging from 5% to 15%, and at least one additive with a weight percentage ranging from 1% to 3% or from 1% to 5% are mixed to form a silver paste.

In some embodiment, the solvent includes propylene glycol, triethylene glycol, butylene glycol, glycero, ethylene glycol, diethylene glycol, dipropylene glycol, or combinations thereof. In some embodiments, the solvent present in the silver paste has a boiling point or range above 180° C., so the solvent does not boil at temperatures ranging from 0° C. to 180° C. In some embodiments, the additive includes surfactant-based leveling agents, leveling agent or combinations thereof. In some embodiments, a mortar and pestle are used during the formation of the silver paste. In some embodiments, the silver particles have an average particle size ranging from 3 μm to 15 μm. They may be in spherical, flake, or plate morphologies, serving as sintering particles for the subsequent sintering process. In some embodiments, in the silver paste, the liquid silver adduct component serves as a silver precursor having a decomposition temperature below 250° C. (e.g., in a range higher than 180° C. and below 250° C.). The reason for selecting these solvents is to maintain the silver paste in a wet medium for the liquid silver adduct, allowing it to decompose into silver nanoparticles during the pre-cure process. Additionally, since the silver adduct is in liquid form, it easily spreads after printing. The additives are selected to ensure good printability and to retain the silver adduct within the printed paste.

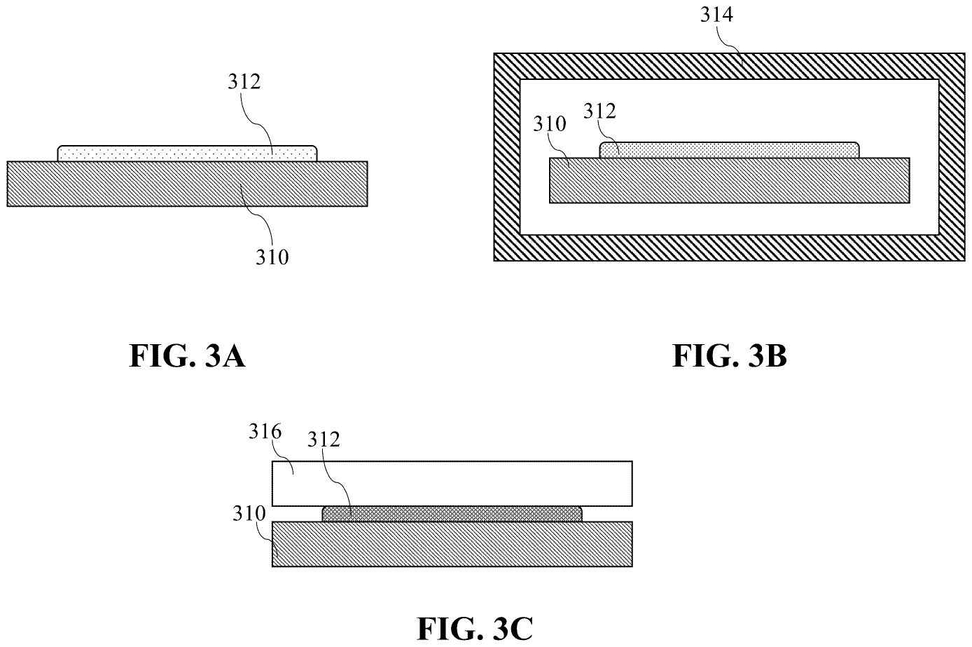

After obtaining the silver paste, step S230 involves the sintering process. In the present invention, the sintering process begins with a low temperature followed by a high temperature, resulting in a significant temperature differential during the bonding and sintering stage. FIGS. 3A, 3B, and 3C depict schematic drawings of a flowchart for the sintering process according to one embodiment of the present invention.

In FIG. 3A, a silver paste 312 is applied to a top surface of a substrate 310. In some embodiments, the substrate 310 is an alumina metalized board (AMB) substrate, and the silver paste 312 is applied to the AMB substrate by using stencil printing.

In FIG. 3B, the substrate 310 with the silver paste 312 thereon is brought to a chamber 314 (e.g., an oven) for a pre-cure process. In one embodiment, a temperature for the pre-cure process ranges from 100° C. to 150° C., and it is conducted over a time period (e.g., 10-30 minutes) under a nitrogen (N₂) atmosphere. In one embodiment, the pre-cure process is performed under both air and nitrogen atmosphere for generation of the liquid silver adduct. In this stage, the silver paste 312 serve as a sintering precursor as it includes the silver adduct as afore-described, which can decompose to form silver nanoparticles in situ during precuring conditions. For example, at precure condition from 100° C. to 150° C., the silver adduct component in the silver paste 312 decomposes and forms silver nanoparticles in situ, and then adheres to and on surfaces of the silver particles. In one embodiment, a temperature for the pre-cure process ranges from 100° C. to 130° C./from 130° C. to 150° C./from 120° C. to 140° C. The formed silver nanoparticles, approximately 10-20 nm in size, easily promote sintering at lower temperature.

In FIG. 3C, a die bonding stage is performed. A die 316 is placed onto the silver paste 312 for bonding to the substrate 310. In one embodiment, the die 316 is a silver-coated SiC die. The die bonding can be performed at a temperature ranging from 120° C. to 140° C., and it is conducted over a time period (e.g., 5-15 seconds; such as 10 seconds).

Thereafter, a sintering stage is performed. Connection of silver particles via the silver nanoparticles is facilitated during high temperature sintering at 200-250° C. under pressure of 5-30 MPa. In one embodiment, the sintering stage is performed in nitrogen atmosphere. In one embodiment, the connection of silver particles via the silver nanoparticles is facilitated using the silver paste 312 at 250° C. for 8 minutes at 20 MPa. In one embodiment, the connection of silver particles via the silver nanoparticles is facilitated using the silver paste 312 at 200 or 250° C. for 5 minutes at 10 or 20 MPa. Table 1 shows samples using different recipes with their performance for hear test result.

TABLE 1

| Sample no. | Sintering stage | Avg. (MPa) |
|---|---|---|
| 1 | 250° C./8 mins/20 MPa | ≥50 MPa |
| 2 | 250° C./8 mins/20 MPa | ≥60 MPa |
| 3 | 250° C./5 mins/20 MPa | ≥70 MPa |
| 4 | 200° C./5 mins/20 MPa | ≥65 MPa |
| 5 | 250° C./5 mins/10 MPa | ≥50 MPa |

In the above, the temperature range is significantly important for improving the yield rate. Regarding the pre-cure condition between 100° C. and 150° C., a pre-cure temperature below 100° C. will result in insufficient silver nanoparticle generation and excessive gassing during the sintering process, leading to reduced shear strength. Conversely, a pre-cure temperature above 150° C. can cause dryness issues on the paste surface, complicating later processes. Regarding the sintering stage condition at 200-250° C., a sintering temperature below 200° C. may result in insufficient sintering and reduced shear strength. While a sintering temperature above 250° C. has little effect on the silver paste, the die itself may not withstand the high temperature.

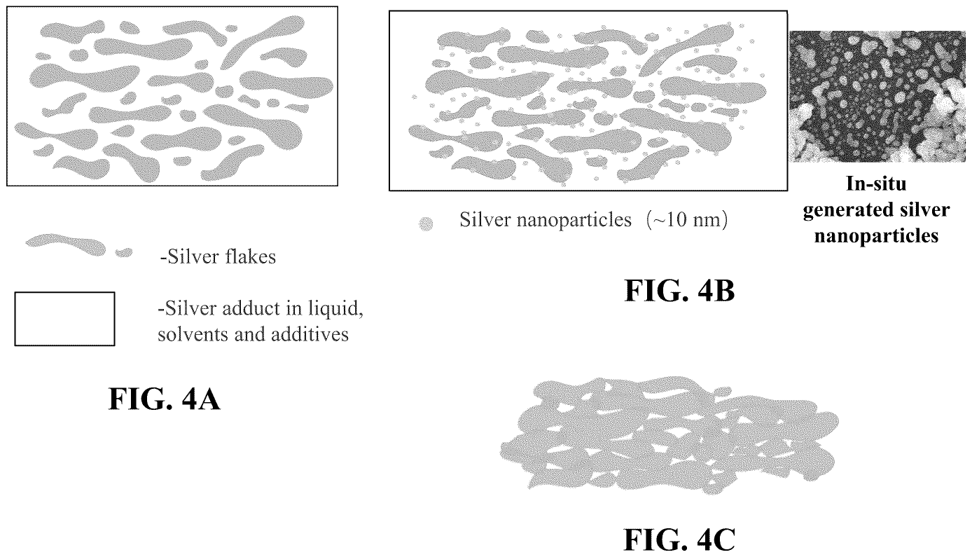

FIGS. 4A, 4B, and 4C are schematic diagrams illustrating the transformation process of the silver paste from a microscopic perspective according to one embodiment of the present invention.

In FIG. 4A, silver flakes are dispersed in a liquid silver adduct component, at least one solvent and at least one additive. In this state, the entire mixture is stable at room temperature, making it easy to store. In FIG. 4B, it is brought into a pre-curing stage. Specifically, the liquid silver adduct component is decomposed into silver nanoparticles in situ and solvents evaporate during the pre-cure process. In one embodiment, the liquid silver adduct component is able to form nanoparticles in a size about 10 nm on in a range from 10 nm to 100 nm. Further, in FIG. 4B, a SEM image shows in-situ generated silver nanoparticles. In FIG. 4C, it is brought into a sintering stage with pressure. The in-situ generated silver nanoparticles can act as a binder to assist sintering of silver particles, forming necking points in therebetween, which can achieve low sintering temperature, low porosity, and high shear strength.

The sintering stage provided by the present invention is not limited to the aforementioned statements. That is, the components to be bonded are not restricted to those described above.

In various embodiments, a method of manufacturing a sintered body is provided using a metal paste to join a first member and a second member. After the sintering, the metal paste can get transformed into a sintered metal layer that joins the first and second member under pressurized condition. The sintered metal layer includes a structure that is derived from spherical, flake, or plate silver particles which are oriented in approximately parallel to an interface between first member and second member. The structure of the sintered metal layer further includes silver nanoparticles on the spherical, flake, or plate-shaped silver particles and attached to the spherical, flake, or plate-shaped silver particles, which are in situ generated by thermal induced decomposition of metallo-organic complex. As such, the first and second members have contact surfaces facing and joining with each other via the sintered metal layer (i.e., they are joined by a compacted metal paste under a pressure condition). Therefore, the method provided by the present invention can achieve a metal surface sintering which nanoparticles and microparticles are interconnected with low air porosity and high shear strength.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A method for low-temperature sintering process using a silver paste, comprising:
forming a silver paste by at least mixing a liquid silver adduct component with a weight percentage ranging from 10% to 20%, silver particles with a weight percentage ranging from 50 to 80%, and at least one solvent with a weight percentage ranging from 5% to 15%, wherein the liquid silver adduct component is a metal-organic complex comprising an organic acid and primary amines coordinated to a silver metal center, serving as a silver precursor with a decomposition temperature below 250° C., and wherein the silver particles have an average particle size ranging from 3 μm to 15 μm;
performing a pre-cure process for the silver paste, comprising heating the silver paste in a heating chamber at a pre-cure temperature ranging from 100° C. to 150° C., such that the silver adduct component in the silver paste decomposes to form silver nanoparticles for adhesion onto surfaces of the silver particles; and
performing a sintering process, comprising heating the pre-cured silver paste under a sintering temperature higher than the pre-cure temperature under pressure of 5-30 MPa to facilitate connection of the silver particles via the silver nanoparticles.

2. The method according to claim 1, wherein the sintering temperature ranges from 200° C. to 300° C.

3. The method according to claim 1, wherein the silver particles have spherical, flake, or plate morphologies.

4. The method according to claim 1, wherein the pre-cure process is conducted over a time period ranging from 10 to 30 minutes under a nitrogen (N₂) atmosphere.

5. The method according to claim 1, further comprising preparing the liquid silver adduct component, comprising:
mixing sodium hydroxide and the organic acid in a mole ratio of A:B in a first aqueous medium to form a first solution, wherein a ratio of A to B ranges from 0.2 to 5;
mixing silver nitrate and the organic acid in a mole ratio of A:B in a second aqueous medium to obtain a second solution;
adding the second solution dropwise into the first solution to obtain silver salt;
filtering and drying the silver salt in a vacuum oven; and
reacting the silver salt with primary amine in a mole ratio of C:D to obtain the liquid silver adduct component, wherein a ratio of C to D ranges from 0.1 to 10.

6. The method according to claim 1, further comprising preparing the liquid silver adduct component, comprising:
mixing silver nitrate and an organic acid in a mole ratio of E:F in an aqueous medium to form a silver salt, wherein a ratio of E to F ranges from 0.2 to 5;
filtering and drying the silver salt in a vacuum oven; and
reacting the silver salt with primary amine in a mole ratio of G:H to obtain a liquid silver adduct component, wherein a ratio of G to H ranges from 0.1 to 2.

7. The method according to claim 1, wherein the organic acid comprises hexanoic acid, octanoic acid, oleic acid, palmitic acid, caprylic acid, arachidic acid, lauric acid, caproic acid, carboxylic acid, myristic acid, stearic acid or combinations thereof, and wherein the liquid silver adduct component is composed of a silver salt of the organic acid with primary amine coordinated to the silver metal center, the primary amine comprises aliphatic primary amine ligands, including heptylamine, tetradecylamine, hexadecylamine, hexylamine, dodecylamine, decylamine, octadecylamine, octylamine, oleylamine and combinations thereof, and wherein the silver salt of the organic acid comprises saturated fatty acids and comprises the aliphatic primary amine ligands composed of straight-chain primary amines.

8. The method according to claim 1, wherein the solvent present in the silver paste has a boiling point or range above 180° C.

9. The method according to claim 1, further comprising:
adding at least one additive with a weight percentage ranging from 1% to 5% to the silver paste.

10. A method for low-temperature sintering process using a silver paste, comprising:
forming a silver paste by at least mixing a liquid silver adduct component with a weight percentage ranging from 10% to 20%, silver particles with a weight percentage ranging from 50 to 80%, and at least one solvent with a weight percentage ranging from 5% to 15%, wherein the liquid silver adduct component is a metal-organic complex comprising a silver salt, an organic acid, and primary amines coordinated to a silver metal center, serving as a silver precursor with a decomposition temperature below 250° C., and wherein the silver particles have an average particle size ranging from 3 μm to 15 μm;
applying the silver paste to a top surface of a substrate;
heating the substrate with the silver paste in a heating chamber at a pre-cure temperature ranging from 100° C. to 150° C., such that the silver adduct component in the silver paste decomposes to form silver nanoparticles for adhesion onto surfaces of the silver particles; and
placing a die onto the silver paste for bonding the die to the substrate, wherein the bonding is performed at a bonding temperature; and
performing a sintering process, comprising heating the pre-cured silver paste under a sintering temperature higher than the pre-cure temperature under pressure of 5-30 MPa to facilitate connection of the silver particles via the silver nanoparticles.

11. The method according to claim 10, wherein the bonding temperature ranges from 120° C. to 140° C., and wherein the sintering temperature ranges from 200° C. to 250° C.

12. The method according to claim 10, wherein the silver particles have spherical, flake, or plate morphologies.

13. The method according to claim 10, wherein the pre-cure process is conducted over a time period ranging from 10 to 30 minutes under a nitrogen (N₂) atmosphere.

14. The method according to claim 10, further comprising preparing the liquid silver adduct component, comprising:
mixing sodium hydroxide and the organic acid in a mole ratio of A:B in a first aqueous medium to form a first solution, wherein a ratio of A to B ranges from 0.2 to 5;
mixing silver nitrate and the organic acid in a mole ratio of A:B in a second aqueous medium to obtain a second solution;
adding the second solution dropwise into the first solution to obtain silver salt;
filtering and drying the silver salt in a vacuum oven; and
reacting the silver salt with primary amine in a mole ratio of C:D to obtain the liquid silver adduct component, wherein a ratio of C to D ranges from 0.1 to 10.

15. The method according to claim 10, further comprising preparing the liquid silver adduct component, comprising:
dissolving silver nitrate and the organic acid in a mole ratio of E:F in an aqueous medium to form a silver salt, wherein a ratio of E to F ranges from 0.2 to 5;
filtering and drying the silver salt in a vacuum oven; and
taking a mole ratio of the silver salt to primary amine in G:H so as to obtain a liquid silver adduct component, wherein a ratio of G to H ranges from 0.1 to 2.

16. The method according to claim 10, wherein the organic acid comprises hexanoic acid, octanoic acid, oleic acid, palmitic acid, caprylic acid, arachidic acid, lauric acid, caproic acid, carboxylic acid, myristic acid, stearic acid or combinations thereof, and wherein the liquid silver adduct component is composed of a silver salt of the organic acid with primary amine coordinated to the metal center, the primary amine comprises aliphatic primary amine ligands, including heptylamine, tetradecylamine, hexadecylamine, hexylamine, dodecylamine, decylamine, octadecylamine, octylamine, oleylamine and combinations thereof, and wherein the silver salt of the organic acid comprises saturated fatty acids and comprises the aliphatic primary amine ligands composed of straight-chain primary amines.

17. The method according to claim 10, wherein the solvent present in the silver paste has a boiling point or range above 180° C.

18. The method according to claim 10, further comprising:
adding at least one additive with a weight percentage ranging from 1% to 5% to the silver paste.

19. A silver paste for low-temperature sintering process, comprising:
a liquid silver adduct component with a weight percentage ranging from 10% to 20%, wherein the liquid silver adduct component is a metal-organic complex comprising a silver salt, an organic acid, and primary amines coordinated to a silver metal center, serving as a silver precursor with a decomposition temperature below 250° C.;
silver particles with a weight percentage ranging from 50 to 80% and having an average particle size ranging from 3 μm to 15 μm; and
at least one solvent with a weight percentage ranging from 5% to 15%.

20. The silver paste according to claim 19, further comprising:
at least one additive with a weight percentage ranging from 1% to 5%.
